(19) United States
(12) Patent Application Publication
(10) Pub. No.: US 2008/0074376 A1
(43) Pub. Date: Mar. 27, 2008

(54) LIQUID CRYSTAL DISPLAY AND METHOD THEREOF

(75) Inventors: Bum-Joon KIM, Seoul (KR); Kon-Ho LEE, Seoul (KR); Jong-Seok CHAE, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/779,961

(22) Filed: Jul. 19, 2007

(30) Foreign Application Priority Data
Sep. 21, 2006 (KR) 10-2006-0091883

(51) Int. Cl. G09G 3/36

(52) U.S. Cl. 345/94

(57) ABSTRACT

The present invention relates to a liquid crystal display (“LCD”) including a display panel assembly having a liquid crystal layer, a driving voltage generator generating driving voltages for the display panel assembly, and a driving unit driving the display panel assembly based on the driving voltages. The driving voltage generator receives information about the display panel assembly from the display panel assembly or from an external device and generates the driving voltages based on the information. Thus, regardless of the characteristics of the display panel, one driving chip is commonly used for various LCDs.

This application claims priority to Korean Patent Application No. 10-2006-0091883, filed on Sep. 21, 2006 and all the benefits accruing therefrom under 35 U.S.C. §119, the contents of which in its entirety are herein incorporated by reference.

### BACKGROUND OF THE INVENTION

(a) Field of the Invention

The present invention relates to a liquid crystal display (“LCD”) and a method thereof. More particularly, the present invention relates to an LCD employing a driving chip usable in varying LCDs, and a method thereof.

(b) Description of the Related Art

Generally, a liquid crystal display (“LCD”) includes a pair of panels, including a plurality of pixel electrodes and a common electrode, and a liquid crystal (“LC”) layer interposed between the panels and having dielectric anisotropy. The pixel electrodes are arranged in a matrix and connected to switching elements such as thin film transistors (“TFTs”). The TFTs are connected to signal lines such as gate lines and data lines to apply data voltages to the pixel electrodes. The pixel electrodes are supplied with data voltages through the TFTs row by row. The common electrode ranges over an entire surface of a panel and is supplied with a common electrode. The pixel electrodes and the common electrode along with the LC layer disposed there between form LC capacitors in an equivalent circuit, and a LC capacitor as well as a switching element is a basic element forming a pixel.

In order to prevent image deterioration due to long-time application of the unidirectional electric field to the LC layer, etc., a polarity of the data voltages with respect to the common voltage is reversed every frame, every row, or every pixel, or polarities of all the common voltage and the data voltages are reversed.

Among the LCDs, an LCD such as a medium- or small-sized LCD for a portable telephone, etc., includes an LC panel assembly, a flexible printed circuit (“FPC”) board having signal lines that transmit input signals from an external device, and a single chip controlling the LC panel assembly, etc.

Meanwhile, magnitudes of driving voltages of the LCD are changed in accordance with the kind of LC or the display type. At this time, a basic voltage that functions as a standard of various driving voltages used in the LCD is generated in a single chip. The single chip generates various basic voltages in order to drive various LCDs each of which has different driving voltages defined by the kind of LC or the display type.

However, even though the single chip generates the various basic voltages, there is a limit to designing one single chip by which various LC panel assembles can be controlled. Moreover, when the single chip generates the various basic voltages for controlling various kinds of LC panel assemblies, it is uneconomical to generate unused basic voltages.

### BRIEF SUMMARY OF THE INVENTION

According to exemplary embodiments of the present invention, an LCD includes a display panel assembly including a liquid crystal layer, a driving voltage generator generating driving voltages for the display panel assembly, and a driving unit driving the display panel assembly based on the driving voltages. The driving voltage generator receives information about the display panel assembly from the display panel assembly or from an external device and generates the driving voltages based on the information.

The information may include the kind of LC that forms the liquid crystal layer and the display type of the display panel assembly, and the display type may be a normally black mode or a normally white mode.

The driving voltage generator may generate a basic voltage based on the information, and the driving voltages may be based on the basic voltage.

The display panel assembly may include an information output unit outputting the information. The LCD may further include a circuit board attached to the display panel assembly and electrically connected to the driving voltage generator and the driving circuit, and the circuit board may include the information output unit outputting the information. The circuit board may be flexible. The information output unit may include at least one pin electrically connected to the driving voltage generator.

The display panel assembly may include a plurality of pixels each having a switching element, and the driving unit may include a gate driver generating gate signals based on at least one of the driving voltages to be applied to the switching elements, a gray voltage generator generating a plurality of gray voltages based on one of the driving voltages, and a data driver generating data voltages based on the gray voltage to be applied to the switching elements. The driving voltages may include a gate-on voltage and a gate-off voltage applied to the gate driver, a reference voltage applied to the gray voltage generator, and a common voltage applied to the pixels.

The driving voltage generator and the driving unit may be implemented as an integrated circuit (“IC”) chip, and the IC chip may be directly mounted on the display panel assembly.

According to other exemplary embodiments of the present invention, an LCD includes a display panel assembly including a liquid crystal layer, a driving voltage generator generating driving voltages for the display panel assembly, and a driving unit driving the display panel assembly based on the driving voltages. The driving voltage generator generates the driving voltages based on information with respect to a kind of LC that forms the liquid crystal layer and a display type of the display panel assembly.

The display type may be a normally black mode or a normally white mode.

The driving voltage generator may generate a basic voltage based on the information, and the driving voltages may be based on the basic voltage.

The display panel assembly may include a plurality of pixels each having a switching element, and the driving unit may include a gate driver generating gate signals based on at least one of the driving voltages to be applied to the switching elements, a gray voltage generator generating a plurality of gray voltages based on one of the driving voltages, and a data driver generating data voltages based on the gray voltage to be applied to the switching elements. The driving voltages may include a gate-on voltage and a gate-off voltage applied to the gate driver, a reference voltage applied to the gray voltage generator, and a common voltage applied to the pixels.

The driving voltage generator and the driving unit may be implemented as an IC chip. The IC chip may be directly mounted on the display panel assembly.

According to still other exemplary embodiments of the present invention, a method of generating driving voltages for an LCD, having a display panel assembly including a liquid crystal layer, includes providing a driving voltage generator, sending information about the display panel assembly to the driving voltage generator, and generating driving voltages based on the information.

Sending information about the display panel assembly may include sending information about a kind of liquid crystal forming the liquid crystal layer and a display type of the display panel assembly. Also, sending information about the display panel assembly may include sending information from the display panel assembly or from an external device.

### BRIEF DESCRIPTION OF THE DRAWINGS

The present invention will become more apparent by describing exemplary and preferred embodiments thereof in detail with reference to the accompanying drawings, in which:

FIG. 1 is an exploded perspective view of an exemplary LCD according to an exemplary embodiment of the present invention;

FIG. 2 is a block diagram of an exemplary LCD according to an exemplary embodiment of the present invention;

FIG. 3 is an equivalent circuit diagram of an exemplary pixel of an exemplary LCD according to an exemplary embodiment of the present invention;

FIG. 4 is a schematic view of the exemplary display panel unit of the exemplary LCD shown in FIG. 1;

FIG. 5 is a schematic diagram functionally representing a portion of the exemplary display panel unit shown in FIG. 4;

FIGS. 6A and 6B are tables describing an exemplary manner for defining a basic voltage based on the kind of LC and the display type according to an exemplary embodiment of the present invention;

FIG. 7 is a schematic view of an exemplary display panel unit of an exemplary LCD according to another exemplary embodiment of the present invention; and

FIG. 8 is an enlarged diagram of a portion of the exemplary display panel unit shown in FIG. 7.

### DETAILED DESCRIPTION OF THE INVENTION

The present invention will be described more fully hereinafter with reference to the accompanying drawings, in which preferred and exemplary embodiments of the invention are shown. As those skilled in the art would realize, the described embodiments may be modified in various different ways, all without departing from the spirit or scope of the present invention. Rather, these embodiments are provided so that this disclosure will be thorough and complete, and will fully convey the scope of the invention to those skilled in the art.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Now, a liquid crystal display (“LCD”) according to exemplary embodiments of the present invention will be described in detail with reference to the accompanying drawings.

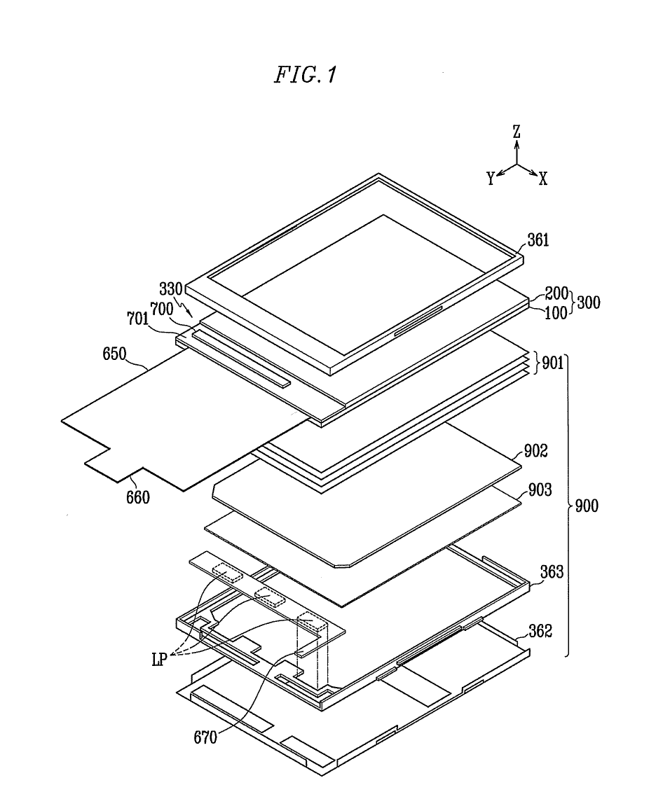

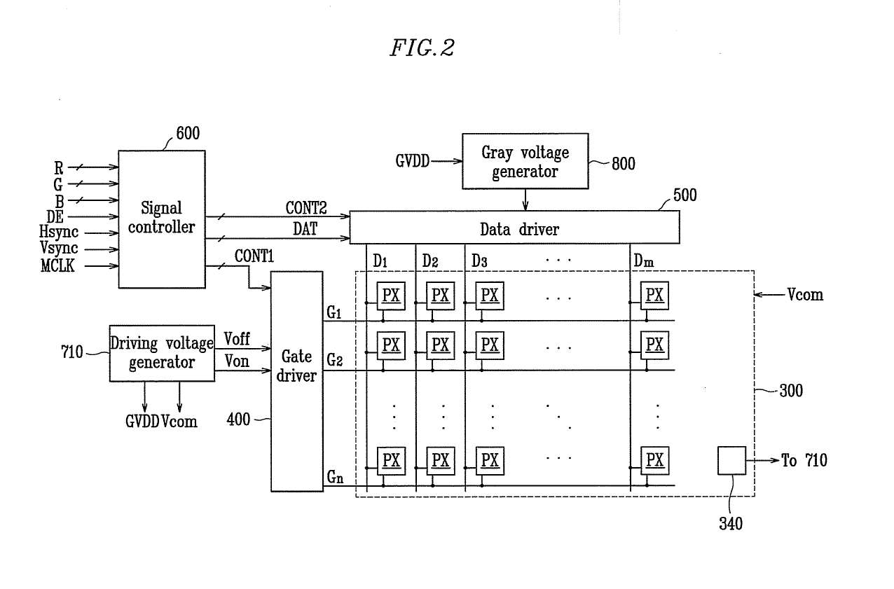

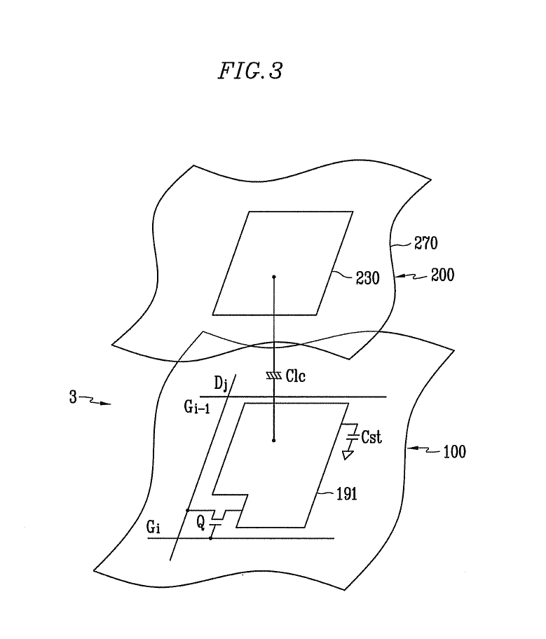

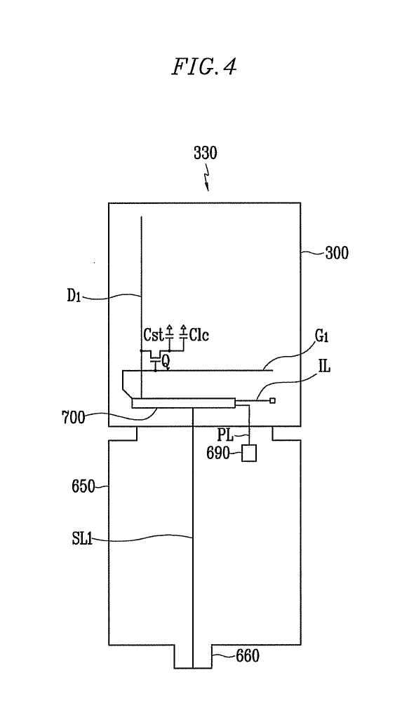

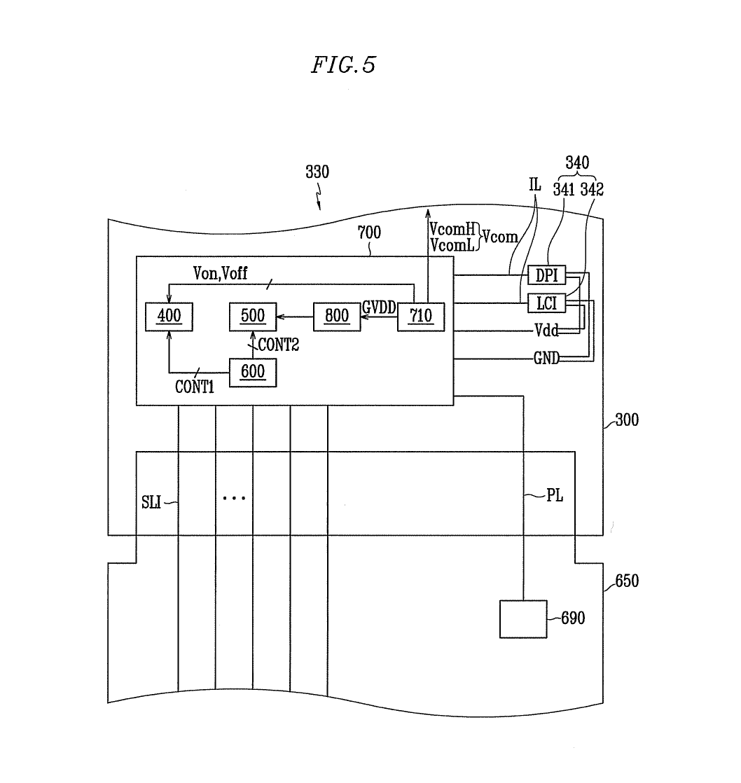

FIG. 1 is an exploded perspective view of an exemplary LCD according to an exemplary embodiment of the present invention, FIG. 2 is a block diagram of an exemplary LCD according to an exemplary embodiment of the present invention, FIG. 3 is an equivalent circuit diagram of an exemplary pixel of an exemplary LCD according to an exemplary embodiment of the present invention, FIG. 4 is a schematic view of the exemplary display panel unit of the exemplary LCD shown in FIG. 1, and FIG. 5 is a schematic diagram functionally representing a portion of the exemplary display panel unit shown in FIG. 4.

Referring to FIG. 1, an LCD according to an exemplary embodiment of the present invention includes a liquid crystal (“LC”) module, upper and lower chassis 361 and 362, and a mold frame 363. The LC module includes a display panel unit 330 and a lighting unit 900.

The display panel unit 330 includes an LC panel assembly 300, a driving chip 700 attached thereto, and a flexible printed circuit (“FPC”) board 650.

Referring to FIGS. 2 and 3, the LC panel assembly 300 includes a plurality of signal lines G₁-Gₙ and D₁-Dₘ, a plurality of pixels PX, and an assembly information output unit 340, in an equivalent circuit. Meanwhile, in the structural view shown in FIG. 3, the LC panel assembly 300 includes lower and upper panels 100 and 200 facing each other and an LC layer 3 interposed between the panels 100 and 200.

The signal lines G₁-Gₙ and D₁-Dₘ are disposed on the lower panel 100 and include a plurality of gate lines G₁-Gₙ transmitting gate signals (also referred to as “scanning signals” hereinafter) and a plurality of data lines D₁-Dₘ transmitting data voltages. The gate lines G₁-Gₙ extend substantially in a row direction or a first direction and substantially parallel to each other, while the data lines D₁-Dₘ extend substantially in a column direction or a second direction and substantially parallel to each other, where the first direction is substantially perpendicular to the second direction.

The pixels PX are arranged in a matrix. Referring to FIG. 3, each pixel PX, for example a pixel PX connected to the i-th gate line Gᵢ (i=1, 2, . . . , n) and the j-th data line Dⱼ (j=1, 2, . . . , m), includes a switching element Q connected to the signal lines Gᵢ and Dⱼ, and an LC capacitor Clc and a storage capacitor Cst that are connected to the switching element Q. In alternative embodiments, the storage capacitor Cst may be omitted.

The switching element Q is disposed on the lower panel 100 and has three terminals, i.e., a control terminal such as a gate electrode connected to the gate line Gᵢ, an input terminal such as a source electrode connected to the data line Dⱼ, and an output terminal such as a drain electrode connected to the LC capacitor Clc and the storage capacitor Cst.

The LC capacitor Clc includes a pixel electrode 191 disposed on the lower panel 100 and a common electrode 270 disposed on the upper panel 200 as two terminals. The LC layer 3 disposed between the two electrodes 191 and 270 functions as a dielectric material of the LC capacitor Clc. The pixel electrode 191 is connected to the switching element Q, such as to the output terminal of the switching element Q, and the common electrode 270 is supplied with a common voltage Vcom and covers an entire surface or substantially an entire surface of the upper panel 200. Alternatively, the common electrode 270 may be provided on the lower panel 100, and at least one of the electrodes 191 and 270 may have a shape of a bar or a stripe.

The storage capacitor Cst is an auxiliary capacitor for the LC capacitor Clc. The storage capacitor Cst includes the pixel electrode 191 and a separate signal line, which is provided on the lower panel 100, overlaps the pixel electrode 191 via an insulator, and is supplied with a predetermined voltage such as the common voltage Vcom. Alternatively, the storage capacitor Cst includes the pixel electrode 191 and an adjacent gate line called a previous gate line, which overlaps the pixel electrode 191 via an insulator.

For color display, each pixel PX uniquely represents one of three colors, such as primary colors (i.e., spatial division) or each pixel PX sequentially represents the colors in turn (i.e., temporal division) such that a spatial or temporal sum of the colors is recognized as a desired color. An example of a set of the colors includes red, green, and blue colors. FIG. 3 shows an example of the spatial division in which each pixel PX includes a color filter 230 representing one of the colors in an area of the upper panel 200 facing the pixel electrode 191. Alternatively, the color filter 230 is provided on or under the pixel electrode 191 on the lower panel 100.

The information output unit 340 outputs information about the LC panel assembly 300. The information may be, for instance, the kind of LC filled in the LC layer 3 and the display type of LCD. For example, the display type may be one of a normally black type and a normally white type. As shown in FIG. 5, the information output unit 340 includes a first output unit 341 outputting information with respect to a display type (referred to as “display type information DPI”, hereinafter) and a second output unit 342 outputting information of the kind of LC (referred to as “LC information LCI”, hereinafter).

Alternatively, while the illustrated information output unit 340 includes both the first and second output units 341 and 342, the information output unit 340 may include only one of the first output unit 341 and the second output unit 342.

One or more polarizers (not shown) are attached to the panel assembly 300. For example, first and second polarized films may be disposed on the lower and upper panels 100, 200 to adjust a transmission direction of light externally provided into the lower and upper panels 100, 200, respectively, in accordance with an aligned direction of the LC layer 3.

Referring to FIG. 1 and FIG. 2 again, the driving chip 700 includes a driving voltage generator 710, a gray voltage generator 800, a gate driver 400, a data driver 500, a signal controller 600, etc. Hereinafter, units 400, 500, 600, and 800, with the exception of the driving voltage generator 710, are referred to as the “driving unit”.

The driving voltage generator 710 generates a basic voltage and voltages (referred to as “driving voltages”) that are voltages required to drive the LCD, such as a gate-on voltage Von and a gate-off voltage Voff for turning on and off the switching elements Q of the pixels PX, a reference voltage GVDD, and the common voltage Vcom, based on the basic voltage.

The gray voltage generator 800 generates a full number of gray voltages or a limited number of gray voltages (referred to as “reference gray voltages” hereinafter) related to the transmittance of the pixels PX based on the reference voltage GVDD from the driving voltage generator 710. Some of the (reference) gray voltages have a positive polarity relative to the common voltage Vcom, while the other of the (reference) gray voltages have a negative polarity relative to the common voltage Vcom.

The gate driver 400 is connected to the gate lines G₁-Gₙ of the LC panel assembly 300 and synthesizes the gate-on voltage Von and the gate-off voltage Voff from the driving voltage generator 710 to generate the gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ. However, when the gray voltage generator 800 generates only a few of the reference gray voltages rather than all the gray voltages, the data driver 500 may divide the reference gray voltages to generate the data voltages from among the reference gray voltages.

The signal controller 600 controls the gate driver 400 and the data driver 500, etc.

All the driving devices 400, 500, 600, 710, and 800 may be integrated into a single integrated circuit (“IC”) chip, but at least one of the driving devices 400, 500, 600, 710, and 800 or at least one circuit element in at least one of the driving devices 400, 500, 600, 710, and 800 may be disposed outside of the single IC chip. Each of driving devices 400, 500, 600, 710, and 800 may include at least one IC chip mounted on the LC panel assembly 300 or on an FPC film in a tape carrier package (“TCP”) type, which are attached to the panel assembly 300. Alternatively, at least one of the driving devices 400, 500, 600, 710, and 800 may be integrated with the panel assembly 300 along with the signal lines G₁-Gₙ and D₁-Dₘ and the switching elements Q.

Referring to FIGS. 1, 4, and 5, the FPC board 650 is attached near one side of the LC panel assembly 300. The FPC board 650 includes a protrusion 660 formed on a side of the FPC board 650 that is opposite to the side of the FPC board 650 that is attached to the LC panel assembly 300. The protrusion 660 is a portion from which signals from an external device are input, and the protrusion 660 and the driving chip 700 are connected to each other via signal lines SL1.

The FPC board 650 includes a passive element unit 690. The passive element unit 690 is connected to the driving voltage generator 710 of the driving chip 700 through a voltage line PL. The passive element unit 690 includes a plurality of passive elements such as capacitors, inductors, and resistors that are required for generating the driving voltages in the driving voltage generator 710. It is preferable that the voltage line PL and the signal lines SL1 are arranged so as not to intersect, and thereby the driving voltage generator 710 may be disposed near an end portion of the driving chip 700.

Referring to FIG. 1 again, a mold frame 363 is positioned between the upper chassis 361 and the lower chassis 362.

The backlight unit 900 includes lamps LP, circuit elements (not shown) controlling the lamps LP, a printed circuit board (“PCB”) 670, a light guide plate 902, a reflective sheet 903, and a plurality of optical sheets 901. The lamps LP are disposed on the PCB 670 that is positioned near an edge of a short side of the mold frame 363, and emits light to a back side of the LC panel assembly 300. The light guide plate 902 guides light from the lamps LP toward the LC panel assembly 300 and uniformly maintains the intensity of the light. The reflective sheet 903 is disposed under the light guide plate 902, and reflects the light from the lamps LP toward the LC panel assembly 300. The optical sheets 901 are disposed over the light guide plate 902 and guarantee luminance characteristics of the light. While a particular embodiment of a backlight unit 900 has been illustrated and described, it should be understood that alternate arrangements of backlight assemblies or alternate lighting units would also be within the scope of these embodiments.

The upper and lower chassis 361 and 362 combine so as to dispose the mold frame 363 there between, to contain the LC module.

Now, operation of the above-described LCD will be described in detail.

The signal controller 600 is supplied with input image signals R, G, and B and input control signals for controlling the display thereof from an external graphics controller (not shown). The input image signals R, G, and B contain luminance information of pixels PX, and the luminance has a predetermined number of grays, for example 1024 (=2¹⁰), 256 (=2⁸), or 64 (=2⁶) grays. The input control signals include a vertical synchronization signal Vsync, a horizontal synchronization signal Hsync, a main clock signal MCLK, and a data enable signal DE.

Based on the input control signals and the input image signals R, G, and B, the signal controller 600 generates gate control signals CONT1 and data control signals CONT2 and it processes the image signals R, G, and B suitable for the operation of the panel assembly 300 and the data driver 500. The signal controller 600 sends the gate control signals CONT1 to the gate driver 400 and sends the processed image signals DAT and the data control signals CONT2 to the data driver 500.

The gate control signals CONT1 include a scanning start signal STV for instructing to start scanning and at least one clock signal for controlling the output period of the gate-on voltage Von. The gate control signals CONT1 may include an output enable signal OE for defining the duration of the gate-on voltage Von.

The data control signals CONT2 include a horizontal synchronization start signal STH for informing of start of data transmission for a row of pixels PX, a load signal LOAD for instructing to apply the data voltages to the data lines D₁-Dₘ, and a data clock signal HCLK. The data control signal CONT2 may further include an inversion signal RVS for reversing the polarity of the data voltages (relative to the common voltage Vcom).

Responsive to the data control signals CONT2 from the signal controller 600, the data driver 500 receives a packet of the digital image signals DAT for the row of pixels PX from the signal controller 600, converts the digital image signals DAT into analog data voltages selected from the gray voltages, and applies the analog data voltages to the data lines D₁-Dₘ.

The gate driver 400 applies the gate-on voltage Von to a gate line G₁-Gₙ in response to the gate control signals CONT1 from the signal controller 600, thereby turning on the switching transistors Q connected thereto. The data voltages applied to the data lines D₁-Dₘ are then supplied to the pixels PX through the activated switching elements Q.

The difference between the voltage of a data voltage and the common voltage Vcom applied to a pixel PX is represented as a voltage across the LC capacitor Clc of the pixel PX, which is referred to as a pixel voltage. The LC molecules in the LC capacitor Clc have orientations depending on the magnitude of the pixel voltage, and the molecular orientations determine the polarization of light passing through the LC layer 3. The polarizer(s) attached to the LC panel assembly 300 converts light polarization to the light transmittance such that the pixel PX has a luminance represented by a gray of the data voltage.

By repeating this procedure by a unit of a horizontal period (also referred to as “1H” and equal to one period of the horizontal synchronization signal Hsync and the data enable signal DE), all gate lines G₁-Gₙ are sequentially supplied with the gate-on voltage Von, thereby applying the data voltages to all pixels PX to display an image for a frame.

When the next frame starts after one frame finishes, the inversion signal RVS applied to the data driver 500 is controlled such that the polarity of the data voltages is reversed (which is referred to as “frame inversion”). The inversion signal RVS may also be controlled such that the polarity of the data voltages flowing in a data line D₁-Dₘ are periodically reversed during one frame (for example, row inversion and dot inversion), or the polarity of the data voltages in one packet are reversed (for example, column inversion and dot inversion).

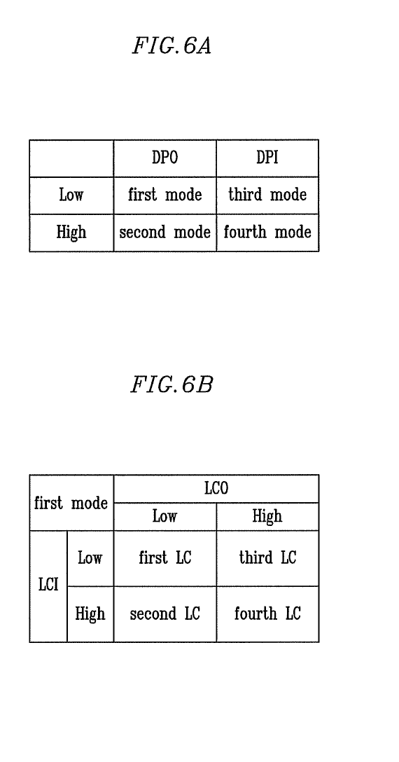

Next, the operation of the driving voltage generator 710 of the LCD according to an exemplary embodiment of the present invention will be described with reference to FIGS. 6A and 6B.

FIGS. 6A and 6B are tables describing an exemplary manner for defining a basic voltage based on the kind of LC and the display type according to an exemplary embodiment of the present invention.

As described above, the driving voltage generator 710 generates a basic voltage in accordance with characteristics of the LC panel assembly 300, and generates the common voltage Vcom, the gate-on voltage Von, the gate-off voltage Voff, the reference voltage GVDD, etc., based on the basic voltage.

With further reference to FIG. 5, the first and second output units 341 and 342 of the information output unit 340 are applied with the voltages Vdd and GND from the driving chip 700, and transmit the display type information DPI and the LC information LCI to the driving chip 700 via an information line or lines IL. In particular, the first and second output units 341 and 342 transmit the display type information DPI and the LC information LCI to the driving voltage generator 710.

The first output unit 341 may include at least one pin. In the illustrated embodiment, the first output unit 341 includes two pins, and referring to FIG. 6A, each pin outputs a high level “High” or low level “Low” signal. An output signal from one of the two pins represents one of a normally black mode and a normally white mode in the display type information DPI, as described above. For example, when the output signal is a high level, the LCD has the normally black mode (a first mode), and when the output signal is a low level, the LCD has the normally white mode (a second mode). However, the relationship of the level of the output signal and the LCD mode may be changed. The other of the two pins may be used to represent other information, as a redundancy pin, in which the LCD has a third mode or a fourth mode.

Referring to FIG. 6B, the second output unit 342 includes at least two pins, and each pin outputs a high level or low level signal. For example, if the first and second pins both output a low level signal, then a first LC type is represented, if the first and second pins both output a high level signal, then a fourth LC type is represented, and second and third LC types are represented when the first and second pins output one of the low level signal and one of the high level signal. Thus, by the combination of the two signals, four LC types are represented.

Thereby, the number of signal combinations of the first output unit 341 and the second output unit 342 may be 16 (=4×4). A basic voltage with respect to each case may be stored in a separate lookup table (“LUT”). The driving voltage generator 710 generates basic voltages based on the LUT and generates the common voltage Vcom, the reference voltage GVDD, the gate-on voltage Von, and the gate-off voltage Voff through the signal processing such as a voltage boosting.

In the meantime, as shown in FIG. 5, the common voltage Vcom generated by the driving voltage generator 710 includes a first level VcomH and a second level VcomL different from the first level VcomH. In this case, an inversion driving by a narrow range of a data voltage is possible, and thereby it is profitable to low voltage driving.

Thereby, when information regarding the characteristics of the LC panel assembly 300 is supplied from the LC panel assembly 300 to the driving voltage generator 710, the driving chip 700 is usable regardless of the kind of LC or the display type.

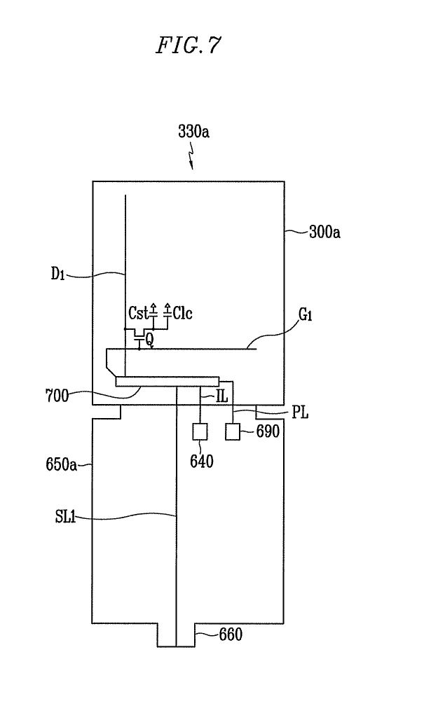

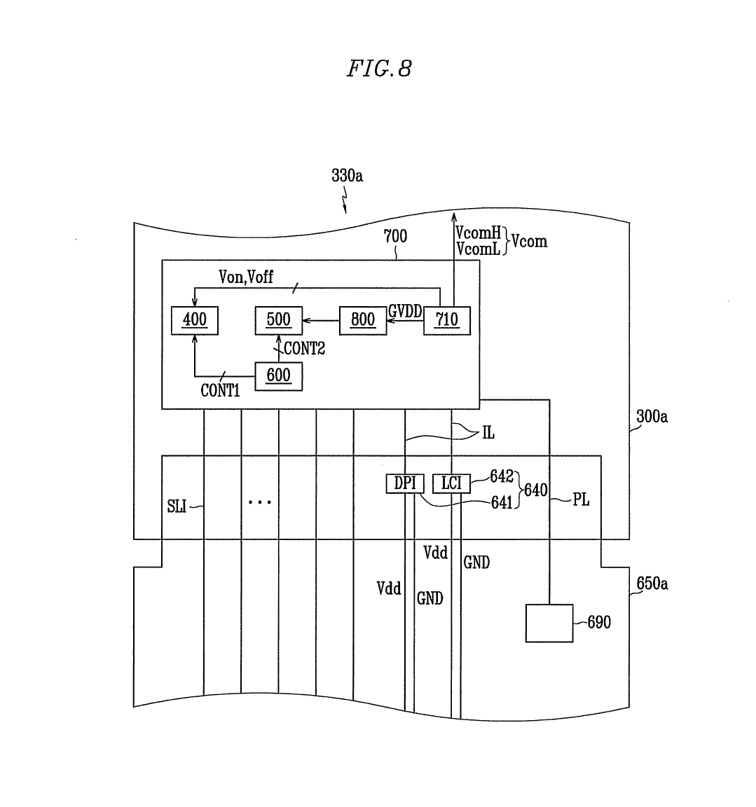

Next, referring to FIGS. 7 and 8, an exemplary LCD according to another exemplary embodiment of the present invention will be described in detail.

FIG. 7 is a schematic view of an exemplary display panel unit of an exemplary LCD according to another exemplary embodiment of the present invention, and FIG. 8 is an enlarged diagram of a portion of the exemplary display panel unit shown in FIG. 7.

A display panel unit 330a shown in FIGS. 7 and 8 is substantially the same as the display panel unit 330 shown in FIGS. 1 to 5. That is, the display panel unit 330a shown in FIGS. 7 and 8 includes an LC panel assembly 300a, a driving chip 700, and an FPC board 650a.

However, in the display panel unit 330a of FIGS. 7 and 8, the FPC board 650a includes an information output unit 640 instead of the LC panel assembly 300a, unlike the LC panel assembly 300 of FIGS. 1 to 5, which includes the information output unit 340. The information output unit 640 includes a first output unit 641 outputting display type information DPI and a second output unit 642 outputting liquid crystal information LCI. Each of the output units 641 and 642 may be directly supplied with voltages Vdd and GND from an external source, and connected to the driving chip 700, and in particular the driving voltage generator 710, through information signal lines IL formed on the LC panel assembly 300a and the FPC board 650a.

As compared with FIGS. 4 and 5, the operation of the information output unit 640 is substantially the same as the information output unit 340, and thus the detailed description thereof is omitted.

According to the present invention, regardless of the characteristics of the LCD, that is, the kind of LC or the display type, one driving chip may be commonly used for various LCDs, thus providing an economical option in the manufacture of LCDs.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a display panel assembly comprising a liquid crystal layer;
a driving voltage generator generating driving voltages for the display panel assembly; and
a driving unit driving the display panel assembly based on the driving voltages,
wherein the driving voltage generator receives information about the display panel assembly from the display panel assembly or from an external device and generates the driving voltages based on the information.

2. The liquid crystal display of claim 1, wherein the information comprises a kind of liquid crystal that forms the liquid crystal layer and a display type of the display panel assembly.

3. The liquid crystal display of claim 2, wherein the display type is a normally black mode or a normally white mode.

4. The liquid crystal display of claim 1, wherein the driving voltage generator generates a basic voltage based on the information, and the driving voltages are based on the basic voltage.

5. The liquid crystal display of claim 1, wherein the display panel assembly comprises an information output unit outputting the information, and the information output unit comprises at least one pin electrically connected to the driving voltage generator.

6. The liquid crystal display of claim 1, further comprising a circuit board attached to the display panel assembly and electrically connected to the driving voltage generator and the driving unit, and the circuit board comprises an information output unit outputting the information.

7. The liquid crystal display of claim 1, wherein the display panel assembly comprises a plurality of pixels each having a switching element, and
the driving unit comprises:
a gate driver generating gate signals based on at least one of the driving voltages to be applied to the switching elements;
a gray voltage generator generating a plurality of gray voltages based on one of the driving voltages; and
a data driver generating data voltages based on one of the gray voltages to be applied to the switching elements.

8. The liquid crystal display of claim 7, wherein the driving voltages comprise a gate-on voltage and a gate-off voltage applied to the gate driver, a reference voltage applied to the gray voltage generator, and a common voltage applied to the pixels.

9. The liquid crystal display of claim 1, wherein the driving voltage generator and the driving unit are implemented as an integrated circuit chip, and the integrated circuit chip is directly mounted on the display panel assembly.

10. The liquid crystal display of claim 1, further comprising a look up table storing the information.

11. The liquid crystal display of claim 1, further comprising an information output unit outputting the information, the information output unit including a first output unit outputting display type information and a second output unit outputting liquid crystal information.

12. A liquid crystal display comprising:
a display panel assembly comprising a liquid crystal layer;
a driving voltage generator generating driving voltages for the display panel assembly; and
a driving unit driving the display panel assembly based on the driving voltages,
wherein the driving voltage generator generates the driving voltages based on information with respect to a kind of liquid crystal that forms the liquid crystal layer and a display type of the display panel assembly.

13. The liquid crystal display of claim 12, wherein the display type is a normally black mode or a normally white mode.

14. The liquid crystal display of claim 12, wherein the driving voltage generator generates a basic voltage based on the information, and the driving voltages are based on the basic voltage.

15. The liquid crystal display of claim 12, wherein the display panel assembly comprises a plurality of pixels each having a switching element, and
the driving unit comprises:
a gate driver generating gate signals based on at least one of the driving voltages to be applied to the switching elements;
a gray voltage generator generating a plurality of gray voltages based on one of the driving voltages; and
a data driver generating data voltages based on the gray voltages to be applied to the switching elements.

16. The liquid crystal display of claim 15, wherein the driving voltages comprise a gate-on voltage and a gate-off voltage applied to the gate driver, a reference voltage applied to the gray voltage generator, and a common voltage applied to the pixels.

17. The liquid crystal display of claim 12, wherein the driving voltage generator and the driving unit are implemented as an integrated circuit chip, and the integrated circuit chip is directly mounted on the display panel assembly.

18. A method of generating driving voltages for a liquid crystal display, the liquid crystal display including a display panel assembly having a liquid crystal layer, the method comprising:
providing a driving voltage generator;
sending information about the display panel assembly to the driving voltage generator; and,
generating driving voltages based on the information.

19. The method of claim 18, wherein sending information about the display panel assembly includes sending information about a kind of liquid crystal forming the liquid crystal layer and a display type of the display panel assembly.

20. The method of claim 18, wherein sending information about the display panel assembly includes sending information from the display panel assembly or from an external device.
